(19) United States
(12) Patent Application Publication
(10) Pub. No.: US 2016/0066568 A1
(43) Pub. Date: Mar. 10, 2016

(54) METHODS AND COMPOSITIONS FOR POLYMER MATRIX SYNTHESIZED BY POLYCONDENSATION

(71) Applicants: Fujun LU, Pudong District, Shanghai (CN); Guoqiang CAI, Hangzhou, Zhejiang (CN); Tong SUN, Pudong New Area, Shanghai (CN); Jianping XU, PuDong New Area, Shanghai (CN); Bruce Alan MENNING, Midland, MI (US); Richard Martin JACOBSON, Chalfont, PA (US); Christian Guy BECKER, King of Prussia, PA (US); AGROFRESH INC., Collegeville, PA (US)

(72) Inventors: Fujun LU, Shanghai (CN); Guoqiang CAI, Hangzhou, Zhejiang (CN); Tong SUN, Shanghai (CN); Jianping XU, Shanghai (CN); Bruce Alan MENNING, Midland, MI (US); Richard Martin JACOBSON, Chalfont, PA (US); Christian Guy BECKER, King of Prussia, PA (US)

(21) Appl. No.: 14/786,702

(22) PCT Filed: Apr. 26, 2013
(86) PCT No.: PCT/CN2013/074819

§ 371 Date: Oct. 23, 2015

(51) Int. Cl. A01N 25/10; A23B 7/154; A01N 25/22; A01N 43/16; A01N 27/00

(52) U.S. Cl. CPC A01N 25/10; A01N 43/16; A01N 27/00; A01N 25/22; A23B 7/154; A23V 2002/00

(57) ABSTRACT

The present invention relates to packaging material/matrix and methods of making such packaging material/matrix for slow or extended release of at least one active volatile compound(s). Provided are methods and compositions for a polymer matrix incorporating at least one active volatile compound (for example 1-methylcyclopropene or 1-MCP) and the polymer matrix is synthesized by polycondensation. This polymer matrix can slowly release the active volatile compound after contacting with a solvent (for example moisture). Also provided is the use of such polymer matrix to prolong the shelf-life of fruits and vegetables.

### BACKGROUND

Ethylene is an important regulator for the growth, development, senescence, and environmental stress of plants; mainly affecting related processes of plant ripening, flower senescence, and leaf abscission. Ethylene is usually generated in large amounts during growth of plants under environmental stress or during preservation and delivery of plants. Therefore yield of plants such as fruit and crop can be reduced under heat or drought stress before harvesting. The commercial value of fresh plants such as vegetables, fruits and flowers after harvesting is reduced by excessive ethylene gas which hastens the ripening of fruits, the senescence of flowers and the early abscission of leaves.

To prevent the adverse effects of ethylene, 1-methylcyclopropene (1-MCP) is used to occupy ethylene receptors and therefore inhibiting ethylene from binding and eliciting action. The affinity of 1-MCP for the receptor is greater than that of ethylene for the receptor. 1-MCP also influences biosynthesis in some species through feedback inhibition. Thus, 1-MCP is widely used for freshness retention post-harvest and plant protection pre-harvest.

But 1-MCP is difficult to handle because it is gas with high chemical activity. To address this problem, 1-MCP gas has been encapsulated successfully by oil-in-water emulsion with 1-MCP gas dissolved in internal oil phase, but the 1-MCP concentration in final product is low (<50 ppm).

Although 1-MCP is an effective ethylene inhibitor to extend the shelf-life of fruit and vegetable by interfering ethylene binding process at the receptor sites, it may only protect floral organs of some species (e.g. Chamelaucium uncinatum Schauer, Pelargonium peltatum L.) against ethylene for 48 to 96 hours. The plant will be sensitive to ethylene again after that, because new ethylene receptors will be generated again. Retreating with 1-MCP is required, but it is not convenient during export handling. Thus, there remains a need for a delivery system for extending the release of volatile compounds including 1-MCP.

### SUMMARY OF INVENTION

The present invention relates to packaging material/matrix and methods of making such packaging material/matrix for slow or extended release of at least one active volatile compound(s). Provided are methods and compositions for a polymer matrix incorporating at least one active volatile compound (for example 1-methylcyclopropene or 1-MCP) and the polymer matrix is synthesized by polycondensation. This polymer matrix can slowly release the active volatile compound after contacting with a solvent (for example moisture). Also provided is the use of such polymer matrix to prolong the shelf-life of fruits and vegetables.

In one aspect, provided is a method of preparing a polymer matrix/packaging material. The method comprises:

(a) providing an active component comprising a molecular complex of an active volatile compound; and
(b) synthesizing a polymer by polycondensation with at least two reactive monomers for encapsulating the active component of (a), thereby resulting in a polymer matrix with encapsulated active component; and;
wherein extended release of the active volatile compound is achieved upon contact of a solvent (for example water or water vapor) as compared to a control molecular complex without encapsulated in the polymer matrix.

In one embodiment, the active volatile compound comprises a cyclopropene compound and the molecular complex comprises the cyclopropene compound encapsulated by a molecular encapsulating agent. In a further embodiment, the cyclopropene compound is of the formula:

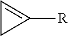

wherein R¹ is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy. In another embodiment, R is C₁₋₈ alkyl. In another embodiment, R is methyl.

In another embodiment, the cyclopropene compound is of the formula:

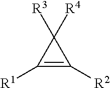

wherein R¹ is a substituted or unsubstituted C₁-C₄ alkyl, C₁-C₄ alkenyl, C₁-C₄ alkynyl, C₁-C₄ cycloalkyl, cylcoalkylalkyl, phenyl, or napthyl group; and R², R³, and R⁴ are hydrogen. In another embodiment, the cyclopropene compound comprises 1-methylcyclopropene (1-MCP).

In one embodiment, the molecular encapsulating agent of any of the above-described embodiments comprises alpha-cyclodextrin, beta-cyclodextrin, gamma-cyclodextrin, or combinations thereof. In another embodiment, the molecular encapsulating agent comprises alpha-cyclodextrin.

In one embodiment, the method further comprises adding at least one absorbent polymer to the matrix. In a further embodiment, the absorbent polymer is selected from the group consisting of poly(vinyl alcohol)(PVA), polyacrylic acid, polyacrylamide, copolymer of acrylic acid and maleic anhydride (AA-MA copolymer), sodium poly(aspartic acid) (sPASp) and combinations thereof.

In another embodiment, the at least two reactive monomers comprise (i) epoxide/aliphatic epoxy and amine hardener, (ii) isocyanate and polyols, (iii) isocyanate and amines/di-amines, and/or (iv) triethyl citrate and amines/di-amines. In another embodiment, the at least two reactive monomers comprise epoxide/aliphatic epoxy and amine hardener. In a further embodiment, the epoxide comprises poly(ethylene glycol) diglycidyl ether (PEGDE) and/or poly(tetramethylene ether) glycol diglycidyl ether. In another embodiment, the amine hardener comprises at least one of poly(aminoethoxy-co-ethoxy)siloxane (PAOS-MEA), polyetheramines, tetraethylenepentamine (TEPA), and trienthylenetetramine. In a further embodiment, ratio by weight of PEGDE and the amine hardener is between 2:1 and 10:1.

In another embodiment, the solvent comprises water or water vapor moisture. In another embodiment, ratio by weight of the active component to combination of the at least two monomers is between 0.05% and 25%; between 0.1% and 10%; or between 1% and 5%. In another embodiment, the step (b) is performed at a temperature between 4° C. and 100° C.; between 25° C. and 80° C.; or between 55° C. and 75° C. In a further embodiment, the step (b) is performed at a temperature between 25° C. and 70° C. In another embodiment, the step (b) is performed with an incubation time from 0.5 hour to 48 hours; from 1 hour to 24 hours; or from 2 hours to 8 hours. In a further embodiment, the step (b) is performed with an incubation time from 2 hours to 48 hours.

In another embodiment, radiation is not used during polycondensation. In another embodiment, the polymer matrix is cast onto an existing package film and then polymerized to form a coating on the existing package film. In another embodiment, no existing package film is used and the polycondensation is performed without support of another package film/packaging material.

In one embodiment, loss of the active volatile compound during step (b) is less than 2%; less than 5%; less than 10%; less than 20%; or less than 25%. In another embodiment, loss of the active volatile compound during step (b) is between 0.1% and 25%; between 1% and 20%; between 1.5% and 10%; or between 2% and 5%.

In another aspect, provided is a packaging material/polymer matrix prepared by the method disclosed herein. In another aspect, provided is the use of the polymer matrix provided herein in the manufacture of a packaging material for delaying ripening of plants parts including fruits. In another aspect, provided is a method of treating plants or plant parts. The method comprises storing said plants or plant parts with the polymer matrix/packaging material as described herein.

In another aspect, provided is a method for preparing slow release packaging material/polymer matrix. The method comprises:

(a) mixing at least two reactive monomers for polycondensation to form a mixture;
(b) dispersing a molecular complex of an active volatile compound into the mixture of step (a); and
(c) curing the mixture into a polymer matrix;
wherein extended release of the active volatile compound is achieved upon contact of a solvent as compared to a control molecular complex without encapsulated in the polymer matrix.

In one embodiment, the polymer matrix is in a gel form. In another embodiment, the active volatile compound comprises a cyclopropene compound and the molecular complex comprises the cyclopropene compound encapsulated by a molecular encapsulating agent. In a further embodiment, the cyclopropene compound is of the formula:

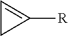

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy. In another embodiment, R is C₁₋₈ alkyl. In another embodiment, R is methyl.

In another embodiment, the cyclopropene compound is of the formula:

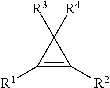

wherein R¹ is a substituted or unsubstituted C₁-C₄ alkyl, C₁-C₄ alkenyl, C₁-C₄ alkynyl, C₁-C₄ cycloalkyl, cycloalkylalkyl, phenyl, or napthyl group; and R², R³, and R⁴ are hydrogen. In another embodiment, the cyclopropene compound comprises 1-methylcyclopropene (1-MCP).

In one embodiment, the molecular encapsulating agent of any of the above-described embodiments comprises alpha-cyclodextrin, beta-cyclodextrin, gamma-cyclodextrin, or combinations thereof. In another embodiment, the molecular encapsulating agent comprises alpha-cyclodextrin.

In one embodiment, the method further comprises adding at least one absorbent polymer to the matrix. In a further embodiment, the absorbent polymer is selected from the group consisting of poly(vinyl alcohol)(PVA), polyacrylic acid, polyacrylamide, copolymer of acrylic acid and maleic anhydride (AA-MA copolymer), sodium poly(aspartic acid) (sPASp) and combinations thereof.

In another embodiment, the at least two reactive monomers comprise (i) epoxide/aliphatic epoxy and amine hardener, (ii) isocyanate and polyols, (iii) isocyanate and amines/di-amines, and/or (iv) triethyl citrate and amines/di-amines. In another embodiment, the at least two reactive monomers comprise epoxide/aliphatic epoxy and amine hardener. In a further embodiment, the epoxide comprises poly(ethylene glycol) diglycidyl ether (PEGDE) and/or poly(tetramethylene ether) glycol diglycidyl ether. In another embodiment, the amine hardener comprises at least one of poly(aminoethoxy-co-ethoxy)siloxane (PAOS-MEA), polyetheramines, tetraethylenepentamine (TEPA), and trienthylenetetramine. In a further embodiment, ratio by weight of PEGDE and the amine hardener is between 2:1 and 10:1.

In another embodiment, the solvent comprises water or water vapor moisture. In another embodiment, ratio by weight of the active component to combination of the at least two monomers is between 0.05% and 25%; between 0.1% and 10%; or between 1% and 5%. In another embodiment, step (a) and/or (c) is performed at a temperature between 4° C. and 100° C.; between 25° C. and 80° C.; or between 55° C. and 75° C. In a further embodiment, step (a) and/or (c) is performed at a temperature between 25° C. and 70° C. In another embodiment, step (a) and/or (c) is performed with an incubation time from 0.5 hour to 48 hours; from 1 hour to 24 hours; or from 2 hours to 8 hours. In a further embodiment, step (a) and/or (c) is performed with an incubation time from 2 hours to 48 hours.

In another embodiment, radiation is not used during polycondensation. In another embodiment, the polymer matrix is casted onto an existing package film and then polymerized into gel to form a coating on the existing package film. In another embodiment, no existing package film is used and the polycondensation is performed without support of another package film/packaging material.

In one embodiment, loss of the active volatile compound during step (b) and/or (c) is less than 2%; less than 5%; less than 10%; less than 20%; or less than 25%. In another embodiment, loss of the active volatile compound during step (b) and/or (c) is between 0.1% and 25%; between 1% and 20%; between 1.5% and 10%; or between 2% and 5%.

In another aspect, provided is a packaging material/polymer matrix prepared by the method disclosed herein. In another aspect, provided is the use of the polymer matrix provided herein in the manufacture of a packaging material for delaying ripening of plants parts including fruits. In another aspect, provided is a method of treating plants or plant parts. The method comprises storing said plants or plant parts with the polymer matrix/packaging material as described herein.

### BRIEF DESCRIPTION OF THE DRAWINGS

FIG. 1A shows a representative illustration for the methods described herein for formation of a polymer matrix by polycondensation. FIG. 1B shows structure of poly(ethylene glycol) diglycidyl ether (PEGDE).

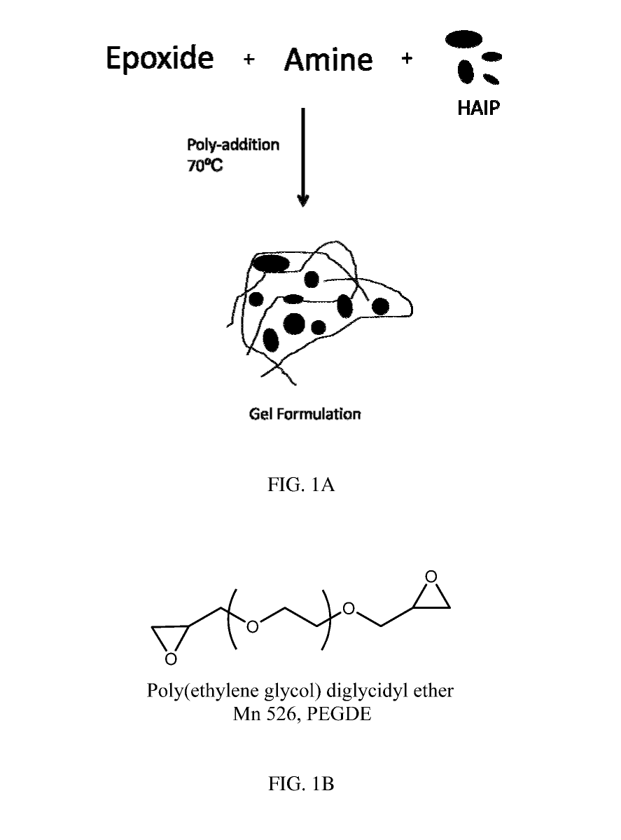

FIG. 2 shows representative release profiles of 1-methylcyclopropene (1-MCP) from Sample 1-2, Sample 1-3, Sample 1-4, and Sample 1-5 (Comparative Example 1) at 90% relative humidity.

FIG. 3 shows representative structures of tetraethyl-enepentamine (TEPA), polyethylenimine (PEI), branched (average MW 25,000), poly(vinyl) alcohol (PVA) and PAOS-MEA.

### DETAILED DESCRIPTION OF THE INVENTION

The gas 1-methylcyclopropene (1-MCP) is a chemical that interferes with the ethylene receptor binding process. The affinity of 1-MCP for the receptors is greater than that of ethylene. In freshness management, 1-MCP is effective in blocking ethylene even at very small concentrations (˜100 ppb). However, 1-MCP is a gas difficult to handle and store; it is also flammable above a concentration of 13,300 ppm. As a result, in current agriculture applications, 1-MCP is usually stabilized as a molecular inclusion complex such as the α-cyclodextrin (α-CD) complex to ease handling during storage and transportation. The active ingredient 1-MCP is caged in α-CD and the resulting crystalline complex, is sometimes called High Active Ingredient Product (HAIP). HAIP is typically composed of 100-150 μm needle-like crystals but can be air-milled to a 3-5 μm fine powder if needed. HAIP product can be stored for up to 2 years without loss of 1-MCP at ambient temperature inside a sealed container lined with a moisture barrier. Although the product is more convenient for the application than the 1-MCP gas itself, it still has some disadvantages: (1) it is in a powder form and thus is difficult to handle in the field or in an enclosed space; and (2) it is water-sensitive, and releases 1-MCP gas completely within a short period of time when in contact with water. Upon contact with water or even moisture, 1-MCP gas will be quickly released at a rate which in not compatible with tank use as most of the gas will be lost in the tank headspace before the product had a chance to be sprayed in the field.

In one aspect, provided is a packaging material containing an active volatile compound (for example 1-methylcyclopropene or 1-MCP) prepared in a polymer matrix to extend release of the active volatile compound. The packaging material can be prepared by the following method:

(a) providing an active component comprising a molecular complex of an active volatile compound (for example molecular complex of 1-MCP and α-cyclodextrin); and
(b) synthesizing a polymer by polycondensation with at least two reactive monomers for encapsulating the active component of (a), thereby resulting a polymer matrix with encapsulated active component;
wherein the at least two reactive monomers comprise (i) epoxide/aliphatic epoxy and amine hardener, (ii) isocyanate and polyols, (iii) isocyanate and amines/di-amines, and/or (iv) triethyl citrate and amines/di-amines;
wherein extended release of the active volatile compound is achieved upon contact of a solvent as compared to a control molecular complex without encapsulation in the polymer matrix.

In one embodiment, absorbent polymers (for example polyacrylic acid, poly(vinyl alcohol), copolymer of acrylic acid and maleic anhydride, or polyacrylamide) can also be incorporated in the matrix to extend or slow down the release of the active volatile compound. In one embodiment, ratio by weight of the absorbent polymers to combination of the at least two monomers is between 1% and 20%.

In another embodiment, the active component can be a Dow commercial product, e.g. SmartFresh™, HAIP, or EthylBloc™. In another embodiment, the solvent comprises water or moisture. In another embodiment, no initiator is used during polycondensation. In another embodiment, the polymer matrix is in a form of bulk gel, powder, or film paste.

In another aspect, provided is a method of preparing a slow release packaging material/matrix for an active volatile compound, comprising,

(a) mixing at least two reactive monomers for polycondensation to form a mixture, wherein the at least two reactive monomers comprise (i) epoxide/aliphatic epoxy and amine hardener, (ii) isocyanate and polyols, (iii) isocyanate and amines/di-amines, and/or (iv) triethyl citrate and amines/di-amines;
(b) dispersing a molecular complex of an active volatile compound (for example a molecular complex of 1-MCP and α-cyclodextrin complex) into the mixture of step (a); and
(c) curing the mixture into a polymer matrix;
wherein extended release of the active volatile compound is achieved upon contact of a solvent as compared to a control molecular complex without encapsulated in the matrix.

In one embodiment, the step (a) is performed at a temperature between 25° C. and 70° C. In another embodiment, the step (a) is performed with an incubation time from 2 hours to 48 hours. In another embodiment, the step (c) does not involve heat or radiation.

In one embodiment, the mixture is cast onto an existing package film (for example polyethylene or polyvinyl alcohol) and then cured to form a coating on the existing package film. In another embodiment, no existing package film is used and the mixture is cured without support of another package film/packaging material. In a further embodiment, the mixture is cured into a packaging material without support of another package film/packaging material.

The packaging material/matrix prepared based on the disclosed process can have at least one of the following advantages: (1) unique structure of the matrix prevents the initial water penetration upon dilution and extends the release rate over a longer period of time; (2) minimal 1-MCP loss as compared to previous formulations; and (3) the final product appears convenient in use, and the formulation is easy to store and transport.

It is also possible to replace HAIP with other active complex containing formulations for example SmartFresh™ or EthylBloc® for ethylene inhibitors, which can be encapsulated into the network matrix provided herein.

Suitable epoxides include poly(ethylene glycol) diglycidyl ether (PEGDE), other polypropylene glycol diglycidyl ethers, or poly(tetramethylene ether) glycol diglycidyl ether with various molecular weights.

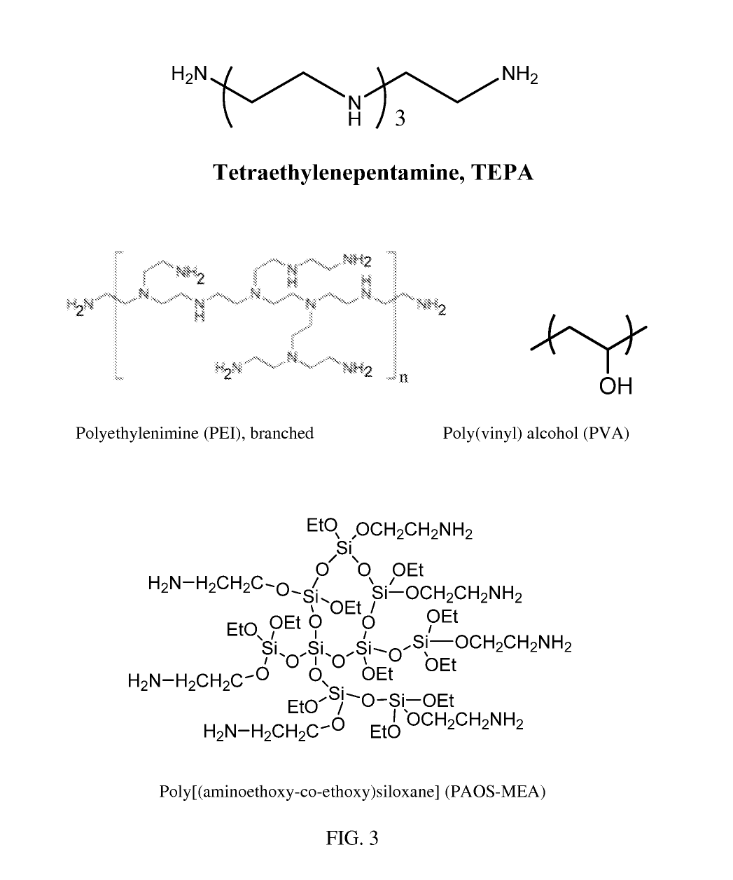

Suitable amine hardeners includes PAOS-MEA (shown in FIG. 3), JEFFAMINE® Polyetheramines, JEFFAMINE® diamines, JEFFAMINE® triamines, tetraethyl-enepentamine, triethyl-enetetramine, or other small molecular organic amines.

Additional examples for the at least two monomers include isocyanate modified polyols and amines where the amines can be JEFFAMINE® polyetheramines or diamines.

In one embodiment, the at least two monomers comprises poly(ethylene glycol) diglycidyl ether (PEGDE) and an amine hardener. In a further embodiment, ratio by weight of PEGDE and the amine hardener is between 2:1 and 10:1.

In another embodiment, ratio by weight of the active component to combination of the at least two monomers is between 0.1% and 10%.

The relative humidity for the application of gel formulation ranges from 50% to 99%.

As used herein, a material is water-insoluble if the amount of that material that can be dissolved in water at 25° C. is 1 gram of material or less per 100 grams of water.

As used herein, when reference is made to a collection of powder particles, the phrase “most or all of the powder particles” means 50% to 100% of the powder particles, by weight based on the total weight of the collection of powder particles.

As used herein, a “solvent compound” is a compound that has boiling point at one atmosphere pressure of between 20° C. and 200° C. and that is liquid at one atmosphere pressure over a range of temperatures that includes 20° C. to 30° C. A “solvent” can be a solvent compound or a mixture of solvents. A non-aqueous solvent can be a solvent that either contains no water or that contains water in an amount of 10% or less by weight based on the weight of the solvent.

As used herein, the phrase “aqueous medium” refers to a composition that is liquid at 25° C. and that contains 75% or more water by weight, based on the weight of the aqueous medium. Ingredients that are dissolved in the aqueous medium are considered to be part of the aqueous medium, but materials that are not dissolved in the aqueous medium are not considered to be part of the aqueous medium. An ingredient is “dissolved” in a liquid if individual molecules of that ingredient are distributed throughout the liquid and are in intimate contact with the molecules of the liquid.

As used herein, when any ratio is said to be X:1 or higher, that ratio is meant to be Y:1, where Y is X or higher. Similarly, when any ratio is said to be R:1 or lower, that ratio is meant to be S:1, where S is R or lower.

The practice of the present invention involves the use of one or more cyclopropene compound. As used herein, a cyclopropene compound is any compound with the formula

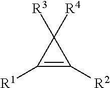

where each R¹, R², R³ and R⁴ is independently selected from the group consisting of H and a chemical group of the formula:

-(L)ₙ-Z

where n is an integer from 0 to 12. Each L is a bivalent radical. Suitable L groups include, for example, radicals containing one or more atoms selected from H, B, C, N, O, P, S, Si, or mixtures thereof. The atoms within an L group may be connected to each other by single bonds, double bonds, triple bonds, or mixtures thereof. Each L group may be linear, branched, cyclic, or a combination thereof. In any one R group (i.e., any one of R¹, R², R³ and R⁴) the total number of heteroatoms (i.e., atoms that are neither H nor C) is from 0 to 6. Independently, in any one R group the total number of non-hydrogen atoms is 50 or less. Each Z is a monovalent radical. Each Z is independently selected from the group consisting of hydrogen, halo, cyano, nitro, nitroso, azido, chlorate, bromate, iodate, isocyanato, isocyanido, isothiocyanato, pentafluorothio, and a chemical group G, wherein G is a 3 to 14 membered ring system.

The R¹, R², R³, and R⁴ groups are independently selected from the suitable groups. Among the groups that are suitable for use as one or more of R¹, R², R³, and R⁴ are, for example, aliphatic groups, aliphatic-oxy groups, alkylphosphonato groups, cycloaliphatic groups, cycloalkylsulfonyl groups, cycloalkylamino groups, heterocyclic groups, aryl groups, heteroaryl groups, halogens, silyl groups, other groups, and mixtures and combinations thereof. Groups that are suitable for use as one or more of R¹, R², R³, and R⁴ may be substituted or unsubstituted.

Among the suitable R¹, R², R³, and R⁴ groups are, for example, aliphatic groups. Some suitable aliphatic groups include, for example, alkyl, alkenyl, and alkynyl groups. Suitable aliphatic groups may be linear, branched, cyclic, or a combination thereof. Independently, suitable aliphatic groups may be substituted or unsubstituted.

As used herein, a chemical group of interest is said to be “substituted” if one or more hydrogen atoms of the chemical group of interest is replaced by a substituent.

Also among the suitable R¹, R², R³, and R⁴ groups are, for example, substituted and unsubstituted heterocyclyl groups that are connected to the cyclopropene compound through an intervening oxy group, amino group, carbonyl group, or sulfonyl group; examples of such R¹, R², R³, and R⁴ groups are heterocyclyloxy, heterocyclylcarbonyl, diheterocyclylamino, and diheterocyclylaminosulfonyl.

Also among the suitable R¹, R², R³, and R⁴ groups are, for example, substituted and unsubstituted heterocyclic groups that are connected to the cyclopropene compound through an intervening oxy group, amino group, carbonyl group, sulfonyl group, thioalkyl group, or aminosulfonyl group; examples of such R¹, R², R³, and R⁴ groups are diheteroarylamino, heteroarylthioalkyl, and diheteroarylaminosulfonyl.

Also among the suitable R¹, R², R³, and R⁴ groups are, for example, hydrogen, fluoro, chloro, bromo, iodo, cyano, nitro, nitroso, azido, chlorato, bromato, iodato, isocyanato, isocyanido, isothiocyanato, pentafluorothio; acetoxy, carboethoxy, cyanato, nitrato, nitrito, perchlorato, allenyl, butylmercapto, diethylphosphonato, dimethylphenylsilyl, isoquinolyl, mercapto, naphthyl, phenoxy, phenyl, piperidino, pyridyl, quinolyl, triethylsilyl, trimethylsilyl; and substituted analogs thereof.

As used herein, the chemical group G is a 3 to 14 membered ring system. Ring systems suitable as chemical group G may be substituted or unsubstituted; they may be aromatic (including, for example, phenyl and napthyl) or aliphatic (including unsaturated aliphatic, partially saturated aliphatic, or saturated aliphatic); and they may be carbocyclic or heterocyclic. Among heterocyclic G groups, some suitable heteroatoms are, for example, nitrogen, sulfur, oxygen, and combinations thereof. Ring systems suitable as chemical group G may be monocyclic, bicyclic, tricyclic, polycyclic, spiro, or fused; among suitable chemical group G ring systems that are bicyclic, tricyclic, or fused, the various rings in a single chemical group G may be all the same type or may be of two or more types (for example, an aromatic ring may be fused with an aliphatic ring).

In one embodiment, one or more of R¹, R², R³, and R⁴ is hydrogen or (C₁-C₁₀) alkyl. In another embodiment, each of R¹, R², R³, and R⁴ is hydrogen or (C₁-C₈) alkyl. In another embodiment, each of R¹, R², R³, and R⁴ is hydrogen or (C₁-C₄) alkyl. In another embodiment, each of R¹, R², R³, and R⁴ is hydrogen or methyl. In another embodiment, R¹ is (C₁-C₄) alkyl and each of R², R³, and R⁴ is hydrogen. In another embodiment, R¹ is methyl and each of R², R³, and R⁴ is hydrogen, and the cyclopropene compound is known herein as 1-methylcyclopropene or “1-MCP.”

In one embodiment, a cyclopropene compound can be used that has boiling point at one atmosphere pressure of 50° C. or lower; 25° C. or lower; or 15° C. or lower. In another embodiment, a cyclopropene compound can be used that has boiling point at one atmosphere pressure of −100° C. or higher; −50° C. or higher; −25° C. or higher; or 0° C. or higher.

The compositions disclosed herein include at least one molecular encapsulating agent. In preferred embodiments, at least one molecular encapsulating agent encapsulates one or more cyclopropene compound or a portion of one or more cyclopropene compound. A complex that includes a cyclopropene compound molecule or a portion of a cyclopropene compound molecule encapsulated in a molecule of a molecular encapsulating agent is known herein as a “cyclopropene compound complex” or “cyclopropene molecular complex.”

In one embodiment, at least one cyclopropene compound complex is present that is an inclusion complex. In a further embodiment for such an inclusion complex, the molecular encapsulating agent forms a cavity, and the cyclopropene compound or a portion of the cyclopropene compound is located within that cavity.

In another embodiment for such inclusion complexes, the interior of the cavity of the molecular encapsulating agent is substantially apolar or hydrophobic or both, and the cyclopropene compound (or the portion of the cyclopropene compound located within that cavity) is also substantially apolar or hydrophobic or both. While the present invention is not limited to any particular theory or mechanism, it is contemplated that, in such apolar cyclopropene compound complexes, van der Waals forces, or hydrophobic interactions, or both, cause the cyclopropene compound molecule or portion thereof to remain within the cavity of the molecular encapsulating agent.

The amount of molecular encapsulating agent can usefully be characterized by the ratio of moles of molecular encapsulating agent to moles of cyclopropene compound. In one embodiment, the ratio of moles of molecular encapsulating agent to moles of cyclopropene compound can be 0.1 or larger; 0.2 or larger; 0.5 or larger; or 0.9 or larger. In another embodiment, the ratio of moles of molecular encapsulating agent to moles of cyclopropene compound can be 10 or lower; 5 or lower; 2 or lower; or 1.5 or lower.

Suitable molecular encapsulating agents include, for example, organic and inorganic molecular encapsulating agents. Suitable organic molecular encapsulating agents include, for example, substituted cyclodextrins, unsubstituted cyclodextrins, and crown ethers. Suitable inorganic molecular encapsulating agents include, for example, zeolites. Mixtures of suitable molecular encapsulating agents are also suitable. In one embodiment, the molecular encapsulating agent comprises alpha-cyclodextrin, beta-cyclodextrin, gamma-cyclodextrin, or combinations thereof. In a further embodiment, the molecular encapsulating agent comprises alpha-cyclodextrin.

In one embodiment, complex powders may have median particle diameter of 100 micrometers or less; 75 micrometers or less; 50 micrometers or less; or 25 micrometers or less. In another embodiment, complex powders may have median particle diameter of 10 micrometers or less; 7 micrometers or less; or 5 micrometers or less. In another embodiment, complex powders may have median particle diameter of 0.1 micrometer or more; or 0.3 micrometer or more. Median particle diameter may be measured by light diffraction using a commercial instrument such as those manufactured, for example, by Horiba Co. or Malvern Instruments.

In another embodiment, complex powders may have median aspect ratio of 5:1 or lower; 3:1 or lower; or 2:1 or lower. If a complex powder is obtained that has undesirably high median aspect ratio, mechanical means may be used, for example, milling, to reduce the median aspect ratio to a desirable value.

The amount of carrier composition provided in the slurry may be characterized by the concentration of cyclopropene compound in the slurry. In one embodiment, suitable slurries may have cyclopropene compound concentration, in units of milligrams of cyclopropene compound per liter of slurry, of 2 or higher; 5 or higher; or 10 or higher. In another embodiment, suitable slurries may have cyclopropene compound concentration, in units of milligrams of cyclopropene compound per liter of slurry, of 1000 or lower; 500 or lower; or 200 or lower.

The slurry may optionally include one or more adjuvants, for example and without limitation, one or more metal complexing agent, alcohol, extender, pigment, filler, binder, plasticizer, lubricant, wetting agent, spreading agent, dispersing agent, sticker, adhesive, defoamer, thickener, transport agent, emulsifying agent or mixtures thereof. Some of such adjuvants commonly used in the art can be found in the John W. McCutcheon, Inc. publication Detergents and Emulsifiers, Annual, Allured Publishing Company, Ridgewood, N.J., U.S.A. Examples of metal-complexing agents, if used, include chelating agents. Examples of alcohols, if used, include alkyl alcohols with 4 or fewer carbon atoms.

In some embodiments, the at least one active volatile compound may comprise one or more plant growth regulators. As used herein, the phase “plant growth regulator” includes, but not limited to, ethylene, cyclopropenes, glyphosate, glufosinate, and 2,4-D. Other suitable plant growth regulators have been disclosed in International Patent Application Publication WO 2008/071714A1, which is incorporated by reference in its entirety.

### EXAMPLES

### Example 1

### Sample Preparation and Testing

Sample 1-1: (1) 0.096 g HAIP (molecular complex of 1-MCP and α-cyclodextrin; 4.5 wt % 1-MCP) is added into 2.500 g poly(ethylene glycol) diglycidyl ether, and 0.814 g PAOS-MEA. The mixture is stirred to form homogeneous slurry under a high speed mechanical stirring; (2) the slurry is incubated at 70° C. to form a gel; (3) the above gel is grounded into powder. Rate of 1-MCP release is measured by directly contacting with liquid water as well as under high humidity conditions.

Sample 1-2: The overall process is similar to that described for Sample 1-1 except that a absorbent polymer, poly(vinyl alcohol) (PVA) is also incorporated. The mass of HAIP is 0.095 g; the mass of poly(ethylene glycol)diglycidyl ether is 2.506 g; and the mass of PAOS-MEA is 0.755 g. The content of PVA is about 10% by weight to the total gel formulation.

Sample 1-3: The overall process is similar to that described for Sample 1-1 except that tetraethylenepentamine is used as the amine hardener. The mass of HAIP is 0.098 g; the mass of poly(ethylene glycol)diglycidyl ether is 2.710 g; and the mass of tetraethylenepentamine is 0.500 g.

Sample 1-4: The overall process is similar to that described for Sample 1-1 except that branched polyethylenimine (PEI) is used as the amine hardener. The mass of HAIP is 0.080 g; the mass of poly(ethylene glycol)diglycidyl ether is 2.128 g; and the mass of branched polyethylenimine (PEI) is 0.600 g

Sample 1-5: (comparative sample): unmodified HAIP composed of α-cyclodextrin and 1-MCP (obtained from AgroFresh Inc.); the content of 1-MCP is 4.5% by weight, based on the weight of the powder.

Total release chemical test procedure: The device to be tested is placed in the bottom of a glass vial and sealed quickly with a septum. Deionized water is injected to fully wet the sample. The vial is placed on a headspace autosampler and mechanically shaken to assist 1-MCP release from the sample. Equilibrium is achieved after a certain period of time at certain temperature and an aliquot of headspace gas in the vial is transferred into gas chromatograph for analysis. Quantification is conducted with known concentration of internal standard.

Release via humidity chemical test procedure: Certain amount of deionized water is injected into a glass vial and the device to be tested is supported above the water by a plastic funnel inside of the vial. Care must be taken not to wet the sample. The vial is sealed with a septum and stored at the test temperature for appropriate time intervals. An aliquot of headspace gas is transferred into the gas chromatograph and the concentration of released 1-MCP is quantified with internal standard calibration.

Release profile chemical test procedure: Samples to be tested are placed in glass vials with the release reagent (deionized water or humidity) in the same way described above.

The vials are sealed with septum and placed on a headspace autosampler with multiple headspace extraction function on. The headspace gas in the vials is transferred repeatedly into gas chromatograph with certain time intervals and a series of chromatograms are obtained which indicted the concentration changes of 1-MCP in the vials.

Stability test: The sample is placed in a 54° C. oven. After 14 days aging, the sample is collected and immersed into water for a full release test.

Gel formation: After polycondensation/polyaddition at 70° C., the slurry is cured to form gel formulation. The gel formulation is ground to powder. Water is added as the release agent to release 1-MCP from the α-cyclodextrin and 1-MCP molecular complex (for example the trade brand EthylBloc® or SmartFresh™). In addition, samples are placed into fruit or vegetable storage carriage and contacted with moisture which is produced by respiration. Extended release of 1-MCP of Samples 1-1 to 1-4 can be effective to prevent the fruit or vegetable spoiled before they are consumed. Accordingly, retreatment of 1-MCP will not be required, so it is convenient for the distributors and dealers to keep the fruit or vegetable fresh.

Total release results: Samples are made as described above. In some cases, the comparative, HAIP is directly applied, and in other cases the samples are ground into powder with millimeter sizes. In some samples, the typically synthesized amine is used as the hardener, and in some other samples, small molecule organic amine is used. In some cases, poly(vinyl alcohol) (PVA) is used as the absorbent polymer and the content of PVA used is about 10% by weight. In all of the samples, the content of HAIP is around 3% by weight, based on the weight of dispersion. The total release (percentage of 1-MCP) is measured and the results are shown in Table 1.

TABLE 1
1-MCP total release (%)

| | | | | | Sample 1-5 |
|---|---|---|---|---|---|
| | Sample | Sample | Sample | Sample | (comparative |
| Full release | 1-1 | 1-2 | 1-3 | 1-4 | sample) |
| 1-MCP release (%) | 56% | 83% | 81% | 78% | 100% |

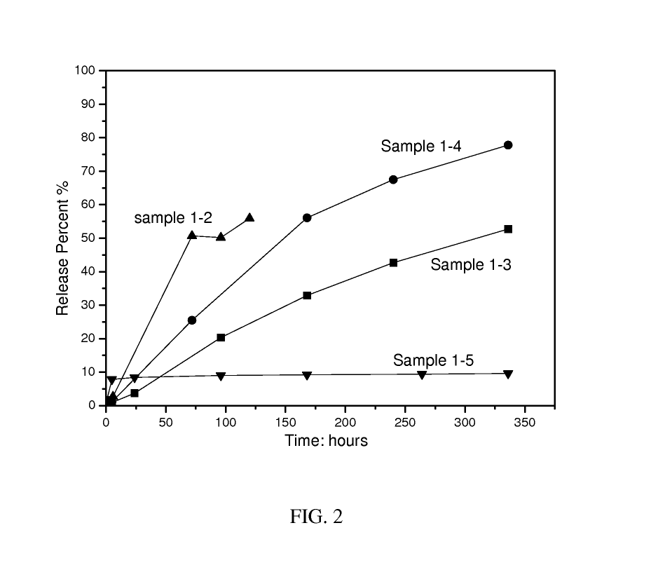

Release via humidity: All samples are ground into powder. Then the powder is placed into a 250 ml vial, where saturated KCl solution is used as the moisture adjusting solution. It gives an 88% relative humidity. Representative results of release profiles are shown in FIG. 2. Only 8% 1-MCP is released for HAIP under these conditions and the 1-MCP is not further released after 20 hours. As Samples 1-2, Sample 1-3, and 1-4 release 52.7%, 77.8%, and 55.9% 1-MCP of their total 1-MCP respectively, these three samples achieve slow/extended release in about 88% relative humidity.

### Example 2

### Additional Control Samples

Control test 1: HAIP (1-MCP/α-CD molecular complex) is obtained from AgroFresh Inc., where 1-MCP is 4.5 wt % based on the total weight of the sample HAIP. Three experiments are repeated to confirm the release of 1-MCP for HAIP by dissolving in water. 20 milligrams of HAIP are added into each of three 250 ml headspace bottles. 2 ml of water is added into the bottles by syringe, and then the bottles are mechanically shaken for two hours. The headspace of each of the three bottles analyzed after 2 hours and about 250 μl of headspace volume is sampled for analysis. In each sampling, the amount of 1-MCP released from HAIP is quantified by gas chromatography wherein cis-2-butene is used as internal standard. The data for these three samples are shown in Table 2.

Control test 2: Saturated salt solution is employed to produce the constant relative humidity of the headspace bottle at constant temperatures. For example, saturated potassium nitrate (KNO₃) solution produced 95% humidity of the headspace bottle at 4° C. Saturated potassium chloride (KCl) solution produced 88% humidity of the headspace bottle at 4° C.

TABLE 2
Headspace concentration of 1-MCP and release
percent of 1-MCP relative to the total value

| Sample # | 1-MCP ppm (v/v) | Release percent (%) |
|---|---|---|
| Sample 2-1 | 1707.9 | 99.8 |
| Sample 2-2 | 1768.6 | 99.6 |
| Sample 2-3 | 1791.1 | 100 |

20 mg HAIP is placed on the top of a headspace bottle which is in a plastic support. The bottle is sealed with a Minnert valve with a septum. 3 ml of saturated potassium nitrate solution is injected into the bottle. Care is taken so that the solution did not contact the sample directly. The bottle is placed in a refrigerator at 4° C. The headspace of each bottle is analyzed at 1, 5, 24, 96, 168, 264, and 336 hours after injection of water wherein about 250 μl of headspace volume is removed for each analysis. In each sampling, the amount of 1-MCP is quantified by gas chromatography wherein cis-2-butene is used as internal standard. Table 3 shows the headspace concentration of 1-MCP and the release percent of 1-MCP relative to total value.

TABLE 3
Headspace concentration of 1-MCP and release
percent of 1-MCP relative to total value

| Hours | 1-MCP ppm (v/v) | Release percent (%) |
|---|---|---|
| 1 | 30.3 | 1.9 |
| 5 | 123.9 | 7.8 |
| 24 | 133.6 | 8.4 |
| 96 | 142.7 | 9.0 |
| 168 | 146.3 | 9.2 |
| 264 | 148.8 | 9.4 |
| 336 | 152.0 | 9.6 |

Control test 3: 20 mg of HAIP is placed in a 54° C. oven for 14 days. Then the aged sample is added into a 250 ml headspace bottle. 2 ml of water is added into the bottle by a syringe, and then the bottle is placed on a mechanical shaker and mixed vigorously for at least 24 hours. After the shaking, 250 μl of the headspace gas is sampled and analyzed at 2, 24 hours by gas chromatography. The headspace concentration of 1-MCP is quantified with cis-2-butene as the internal standard. It showed that 70% of the 1-MCP is still retained for after the aging, this predicts that 30% of 1-MCP can be lost during the 2 years storage at room temperature for the HAIP.

### Example 3

### Additional Test Sample

Sample 3-1 (test sample): 0.096 g HAIP is added into 2.500 g poly(ethylene glycol) diglycidyl ether, and followed by 0.814 g PAOS-MEA (see FIG. 3). The mixture is blended well via mechanical stirrer at 1500 rpm to form homogeneous slurry. Care is taken so that the moisture and water are excluded during the whole reaction. The slurry in incubated at 70° C. for 2 hours forming a gel. The formulation is ground into powder by an IKA® A11 Basic grinder. The average particle size of the powder is around 1 mm.

Full release of the test sample: 212 mg of Sample 3-1 is added into a 250 ml headspace bottle. The bottle is sealed with a Minnert valve with a septum. 3 ml of water is added into the bottle by a syringe, and then the bottle is placed on a mechanical shaker and mixed vigorously for 24 hours. The headspace concentration of 1-MCP is analyzed at 24 hours and quantified with cis-2-butene as internal standard. Result is shown in Table 4.

TABLE 4
Headspace concentration of 1-MCP and release percent
of 1-MCP relative to total value for Sample 3-1

| Hours | 1-MCP ppm (v/v) | Release percent (%) |
|---|---|---|
| 24 | 263.6 | 56.3 |

### Example 4

### Additional Test Sample

Sample 4-1 (test sample): 0.098 g HAIP is added into 2.710 g poly(ethylene glycol) diglycidyl ether, and followed by 0.500 g tetraethylenepentamine. The mixture is blended well via mechanical stirrer at 1500 rpm to form homogeneous slurry. Care is taken so that the moisture and water excluded during the whole reaction. The slurry is reacted at 70° C. for 2 hours. After gel formation the formulation is ground into powder by an IKA®-A11 Basic grinder. The average particle size of the powder is around 1 mm.

Full release: 108 mg powder sample is added into a 250 ml headspace bottle. The bottle is sealed with a Minnert valve with a septum. 3 ml of water is added into the bottle by a syringe, and then the bottle is placed on a mechanical shaker and mixed vigorously for 24 hours. The headspace concentration of 1-MCP is analyzed at 24 hours and quantified with cis-2-butene as internal standard. Table 3 showed the data of the headspace concentration of 1-MCP and the release percent of 1-MCP relative to total value. Result is shown in Table 5.

TABLE 5
Headspace concentration of 1-MCP and release percent
of 1-MCP relative to total value for Sample 4-1

| Hours | 1-MCP ppm (v/v) | Release percent (%) |
|---|---|---|
| 24 | 212.1 | 81.2 |

Slow release: 241 mg of powder product is placed on the top of a headspace bottle supported by a plastic. The bottle is sealed with a Minnert valve with a septum. 3 ml potassium chloride (KCl) is injected into the bottle, which produces the humidity around 88% for the bottle at 4° C. Care is taken so that the solution does not contact the sample directly. The bottle is placed in a refrigerator at 4° C. The headspace gas of the bottle is analyzed at 5, 24, 96, 168, 240, and 336 hours after injection of water wherein about 250 μl of headspace volume is removed for each analysis. In each sampling, the amount of 1-MCP is quantified by gas chromatography with cis-2-butene as internal standard. Results are shown in Table 6. For Sample 4-1, 52.7% of 1-MCP is released over 336 hours (14 days) in 88% percent humidity. Also 1-MCP release can still be observed in 88% percent humidity, suggesting that 1-MCP release can be extended longer than 14 days.

TABLE 6
Headspace concentration of 1-MCP and release percent
of 1-MCP relative to total value For Sample 4-1

| Hours | 1-MCP ppm (v/v) | Release percent (%) |
|---|---|---|
| 5 | 4.4 | 0.9 |
| 24 | 17.5 | 3.7 |
| 96 | 96.0 | 20.3 |
| 168 | 155.6 | 32.9 |
| 240 | 201.8 | 42.7 |
| 336 | 249.4 | 52.7 |

### Example 5

### Additional Test Sample

Sample 5-1: 0.080 g HAIP is added into 2.128 g poly(ethylene glycol) diglycidyl ether, and followed by 0.600 g branched Polyethylenimine (PEI) (see FIG. 3). The mixture is blended well via mechanical stirrer at 1500 rpm to form homogeneous slurry. Care is taken so that the moisture and water are excluded during the whole reaction. The slurry is incubated at 70° C. for 2 hours. After gel formation the formulation is ground into powder by an IKA® A11 Basic grinder. The average particle size of the powder is around 1 mm.

Full release: 245 mg Sample 5-1 is added into a 250 ml headspace bottle. The bottle is sealed with a Minnert valve with a septum. 3 ml of water is added into the bottle by a syringe, and then the bottle is placed on a mechanical shaker and mixed vigorously for 5 hours. The headspace concentration of 1-MCP is analyzed and quantified with cis-2-butene as internal standard. Results are shown in Table 7.

TABLE 7
Headspace concentration of 1-MCP and release percent
of 1-MCP relative to total value for Sample 5-1

| Hours | 1-MCP ppm (v/v) | Release percent (%) |
|---|---|---|
| 2 | 397.6 | 75.2 |
| 5 | 412.7 | 78.1 |

Slow release: 242 mg of Sample 5-1 is placed on the top of a headspace bottle which is supported by a plastic. The bottle is sealed with a Minnert valve with a septum. 3 ml potassium chloride (KCl) is injected into the bottle, which produces the humidity around 88% for the bottle at 4° C. Care is taken so that the solution does not contact the sample directly. The bottle is placed in a refrigerator at 4° C. The headspace gas of the bottle is analyzed at 3, 5, 72, 168, 240, and 336 hours after injection of water wherein about 250 μl of headspace volume is removed for each analysis. In each sampling, the amount of 1-MCP is quantified by gas chromatography with cis-2-butene as internal standard. Results are shown in Table 8. For Sample 5-1, 1-MCP release can be observed over 336 hours (14 days) in 88% percent humidity.

TABLE 8
Headspace concentration of 1-MCP and release percent of
1-MCP relative to actual total value For Sample 5-1

| Hours | 1-MCP ppm (v/v) | Release percent (%) |
|---|---|---|
| 3 | 3.1 | 0.8 |
| 5 | 4.6 | 1.1 |
| 72 | 105.1 | 25.5 |
| 168 | 231.2 | 56.1 |
| 240 | 278.3 | 67.5 |
| 336 | 320.6 | 77.8 |

### Example 6

### Additional Test Sample with Water Absorbent Polymer

Sample 6-1: 0.095 g HAIP is added into 2.506 g poly(ethylene glycol) diglycidyl ether, and followed by 0.755 g PAOS-MEA and 0.302 g poly(vinyl) alcohol (PVA) (see FIG. 3). The mixture is blended well via mechanical stirrer at 1500 rpm to form homogeneous slurry. Care is taken so that the moisture and water are not involved into the reaction during the whole reaction. The slurry is reacted at 70° C. for 2 hours. Gel formulation is ground into powder by an IKA® A11 Basic grinder. The average particle size of the powder is around 1 mm.

Full release: 217 mg Sample 6-1 is added into a 250 ml headspace bottle. The bottle is sealed with a Minnert valve with a septum. 3 ml of water is added into the bottle by a syringe, and then the bottle is placed on a mechanical shaker and mixed vigorously for 24 hours. The headspace concentration of 1-MCP is analyzed and quantified with cis-2-butene as internal standard. Results are shown in Table 9.

TABLE 9
Headspace concentration of 1-MCP and release percent
of 1-MCP relative to total value for Sample 6-1

| Hours | 1-MCP ppm (v/v) | Release percent (%) |
|---|---|---|
| 6 | 382.3 | 83.8 |
| 24 | 378.0 | 82.9 |

Slow release: 232 mg of Sample 6-1 is placed on the top of a headspace bottle supported by a plastic. The bottle is sealed with a Minnert valve with a septum. 3 ml potassium chloride (KCl) is injected into the bottle, which produces the humidity around 88% for the bottle at 4° C. Care is taken so that the solution does not contact the sample directly. The bottle is placed in a refrigerator at 4° C. The headspace gas of the bottle is analyzed at 6, 72, 96, and 120 hours after injection of water wherein about 250 μl of headspace volume is removed for each analysis. In each sampling, the amount of 1-MCP is quantified by gas chromatography with cis-2-butene as internal standard. Results are shown in Table 10. For Sample 6-1, 55.9% of 1-MCP release can be observed over 120 hours in 88% percent humidity and the 1-MCP is released relatively fast up to about 72 hours.

TABLE 10
Headspace concentration of 1-MCP and release percent
of 1-MCP relative to total value For Sample 6-1

| Hours | 1-MCP ppm (v/v) | Release percent (%) |
|---|---|---|
| 6 | 10.9 | 2.7 |
| 72 | 205.0 | 50.7 |
| 96 | 202.9 | 50.2 |
| 120 | 226.0 | 55.9 |

1. A method of preparing a polymer matrix, comprising,
(a) providing an active component comprising a molecular complex of an active volatile compound; and;
(b) synthesizing a polymer by polycondensation with at least two reactive monomers for encapsulating the active component of (a), thereby resulting in a polymer matrix with encapsulated active component; and
wherein extended release of the active volatile compound is achieved upon contact of a solvent as compared to a control molecular complex without encapsulated in the polymer matrix.

2. The method of claim 1, wherein the active volatile compound comprises a cyclopropene compound and the molecular complex comprises the cyclopropene compound encapsulated by a molecular encapsulating agent.

3. The method of claim 2, wherein the cyclopropene compound is of the formula: 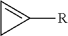
wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy.

4. The method of claim 3, wherein R is C₁₋₈ alkyl.

5. The method of claim 3, wherein R is methyl.

6. The method of claim 2, wherein the cyclopropene compound is of the formula: 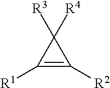
wherein R¹ is a substituted or unsubstituted C₁-C₄ alkyl, C₁-C₄ alkenyl, C₁-C₄ alkynyl, C₁-C₄ cycloalkyl, cycloalkylalkyl, phenyl, or napthyl group; and R², R³, and R⁴ are hydrogen.

7. The method of claim 2, wherein the cyclopropene compound comprises 1-methylcyclopropene (1-MCP).

8. The method of claim 2, wherein the molecular encapsulating agent comprises alpha-cyclodextrin, beta-cyclodextrin, gamma-cyclodextrin, or combinations thereof.

9. The method of claim 2, wherein the molecular encapsulating agent comprises alpha-cyclodextrin.

10. The method of claim 1, further comprising adding at least one absorbent polymer to the matrix.

11. The method of claim 10, wherein the absorbent polymer is selected from the group consisting of poly(vinyl alcohol)(PVA), polyacrylic acid, polyacrylamide, copolymer of acrylic acid and maleic anhydride (AA-MA copolymer), sodium poly(aspartic acid) (sPASp) and combinations thereof.

12. The method of claim 1, wherein the at least two reactive monomers comprise
(i) epoxide/aliphatic epoxy and amine hardener, (ii) isocyanate and polyols, (iii) isocyanate and amines/di-amines, and/or (iv) triethyl citrate and amines/di-amines.

13. The method of claim 1, wherein the at least two reactive monomers comprise epoxide/aliphatic epoxy and amine hardener.

14. The method of claim 13, wherein the epoxide comprises poly(ethylene glycol) diglycidyl ether (PEGDE) and/or poly(tetramethylene ether) glycol diglycidyl ether.

15. The method of claim 13, wherein the amine hardener comprises at least one of PAOS-MEA, polyetheramines, tetraethylenepentamine (TEPA), and triethylenetetramine.

16. The method of claim 14, wherein ratio by weight of PEGDE and the amine hardener is between 2:1 and 10:1.

17. The method of claim 1, wherein ratio by weight of the active component to combination of the at least two monomers is between 0.1% and 10%.

18. The method of claim 1, wherein the step (b) is performed at a temperature between 25° C. and 70° C.

19. The method of claim 1, wherein the step (b) is performed with an incubation time from 2 hours to 48 hours.

20. A polymer matrix prepared according to the method of claim 1.

21.-43. (canceled)
